(19) United States
(12) Patent Application Publication
(10) Pub. No.: US 2007/0291025 A1
(43) Pub. Date: Dec. 20, 2007

(54) Method and apparatus for music enhanced messaging

(76) Inventor: Sami Paihonen, Suomi (FI)

Correspondence Address: PERMAN & GREEN, 425 POST ROAD, FAIRFIELD, CT, 06824, US

(21) Appl. No.: 11/471,469

(22) Filed: Jun. 20, 2006

(51) Int. Cl. G09G 5/00

(52) U.S. Cl. 345/213

(57) ABSTRACT

An apparatus including a processor connected to a user interface and a text conversion device connected to the processor, the text conversion device being configured to convert text input through the user interface into a musical composition.

### BACKGROUND

1. Field

The disclosed embodiments relate to text messaging and, more particularly, to musically enhanced text messaging.

2. Brief Description of Related Developments

Conventional mobile telecommunication devices, such as mobile phones, have the capability of sending text messages by typing in the letters and words using the keypad of the device. As a user presses each key, the letter(s) corresponding to a particular key are displayed on a display of the device. These conventional devices may also have a ring tone composer that may allow a user to create customized ring tones using the keypad of the device. However, in these conventional devices the ring tone composer and the text messaging function are separate entities.

It would be advantageous to associate a musical composition with a text message being sent or received by a mobile device.

### SUMMARY

In one exemplary embodiment, an apparatus is provided. The apparatus includes a processor connected to a user interface and a text conversion device connected to the processor, the text conversion device being configured to convert text input through the user interface into a musical composition.

In accordance with another exemplary embodiment, a method is provided. The method includes detecting at least one key input to a user interface of a device, the at least one key input being used to form a message to be sent to a receiving device, forming a musical composition from the at least one key input, and transmitting the musical composition from the device to the receiving device when the message is sent to the receiving device.

In accordance with one exemplary embodiment a computer program product is provided. The computer program product includes a computer useable medium having computer readable code means embodied therein for causing a computer to form a musical composition. The computer readable code means in the computer program product includes computer readable code means for causing a computer to detect at least one key input to a user interface of a device, the at least one key input being used to form a message to be sent to a receiving device, computer readable code means for causing a computer to form a musical composition from the at least one key input, and computer readable code means for causing a computer to transmit the musical composition from the device to the receiving device when the message is sent to the receiving device.

### BRIEF DESCRIPTION OF THE DRAWINGS

The foregoing aspects and other features of the present embodiments are explained in the following description, taken in connection with the accompanying drawings, wherein:

FIG. 1A is a schematic diagram of a communication device incorporating features of the disclosed embodiments;

FIG. 1B illustrates a mobile phone in accordance with an exemplary embodiment;

FIG. 2 illustrates a musical scale of a composer in accordance with an exemplary embodiment;

FIG. 3 illustrates an alphanumeric representation of a musical composition in accordance with an exemplary embodiment;

FIG. 4 illustrates a flow chart in accordance with a method of an exemplary embodiment; and

FIG. 5 is a block diagram of one embodiment of a typical apparatus that may be used to practice the features of the disclosed embodiments.

### DETAILED DESCRIPTION OF THE EXEMPLARY EMBODIMENT(S)

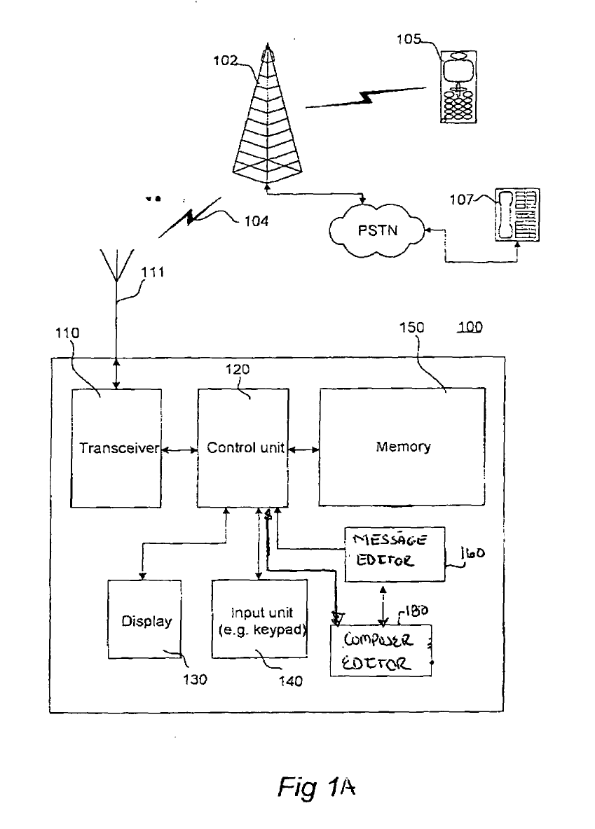

Referring to FIG. 1A, one example of a device 100, such as a mobile communication device, incorporating features of the disclosed embodiments, is shown. Although examples of the invention will be described with reference to the exemplary embodiments shown in the drawings and described below, it should be understood that the examples of the invention could be embodied in many alternate forms of embodiments. In addition, any suitable size, shape or type of elements or materials could be used.

FIG. 1A is a schematic block diagram of a mobile telecommunication terminal 100 according to one embodiment. This system and the mobile communication terminal of FIG. 1A are used for ease of illustrating the disclosed embodiments and such illustrations are not intended to limit the aspects of the invention as claimed herein. A communication unit including a transceiver 110 is used for communicating with a base station 102 via an antenna 111. The base station 102 is in communication with other mobile telecommunication terminals 105 via a mobile communications network, and stationary terminals 107 via e.g. a public switched telephone network (PSTN).

Within communication device 100, a control unit 120 is coupled to the transceiver 110. The control unit 120 may comprise signal processing circuitry in order to process e.g. voice data and message data (e.g. SMS or MMS) from a user of the telecommunication terminal 100 and provide the transceiver 110 with the processed data for transmission to the base station 102. Likewise, the control unit 120 may comprise signal processing circuitry for processing data received from the other telecommunication terminals 105, 107 in order to provide the user of the mobile telecommunication terminal 100 with e.g. audio, image, video or message data. Alternatively (not shown) some or all of the signal processing functionality may be provided by specialized circuitry in the telecommunication terminal 100.

The control unit 120 is coupled to a main display 130 for providing a user of the telecommunication terminal 100 with visual data regarding e.g. a specific call in progress, telecommunication numbers stored in the mobile telecommunication terminal 100, signal strength of the wireless communication link 104, messages received from other telecommunication terminals, etc.

The control unit 120 is moreover coupled to an input unit 140, which may be in the form of a keyboard/keypad; an on-screen touch-sensitive keyboard; a navigation wheel or joystick for scrolling and selecting items, digits and/or characters shown on the display 130; and a microphone for receiving sound signals such as voice.

The control unit 120 can also be connected to a message editor 160, which can be used to create and compose text messages. The composer editor 180 can be used to translate a text message formed in the text message editor 160 into a musical melody or composition in accordance with the features of the disclosed embodiments.

In one embodiment, the communication device 100 illustrated in FIG. 1A can comprise a mobile communication device, such as for example a mobile phone. In alternate embodiments, the device 100 can comprise any suitable communication device. Referring to FIG. 1B, an example of a communications device that can be used to practice aspects of the invention is shown.

As can be seen in FIG. 1B, the mobile device may be a mobile phone such as the block phone 100. In alternate embodiments, the mobile device may be a flip phone, a PDA, a tablet computer or any other suitable device capable of sending a message. The messages sent by the mobile device 100 may be any suitable message such as a text message, an email message or any other message having associated text.

The mobile phone 100 may have a power key 1, an earpiece 2, a display 3, a navigation or selection key 4, scroll keys 5, an ITU-T alphanumeric keyboard 6, a microphone 7 and a clear key 8. The display may be a conventional display or it may be touch enabled display for use with any suitable pointing device such as a stylus or the user's finger.

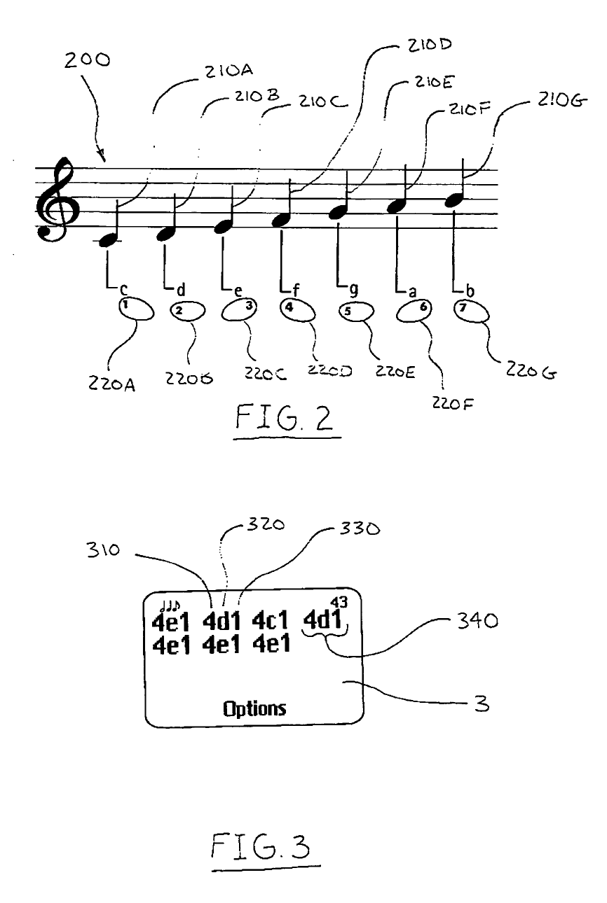

A user of the mobile phone 100 may want to associate a musical composition or melody with a text message being sent from the mobile phone 100. In accordance with one embodiment, the mobile phone 100 may have a musical composer function or editor 180 (i.e. a ring tone composer) associated with the text messaging function of the mobile phone 100. The composition function and text messaging function may be associated in any suitable manner such as through application interworking where once the text message is completed, the composer is automatically launched and transposes the text message into a musical composition. The composer 180 may be run either in the background so that its operation is transparent to the user or the transposition of the text into musical notes may be displayed on display 3 for the user to see and/or modify as shown in FIG. 3. It should be understood that each of the composer function and the text messaging function may be used individually if desired. For example, there may be a text messaging setting of the mobile phone 100 that may be accessed through a menu function of the mobile phone 100. In the text messaging setting there may be a sub-menu for activating and deactivating the association between the composer and text message functions so that when activated the text messages are transposed into musical compositions and when deactivated the text messages are sent as a convention text message. In alternate embodiments the musical composition feature associated with the text messages may be activated in any suitable manner such as for example, a dedicated key or a user defined key. An option to transpose the text message into music may also be presented to the user each time a message is ready to be sent in that a dialogue box or similar selection option may be presented to the user asking whether the user wants to convert the text message into music.

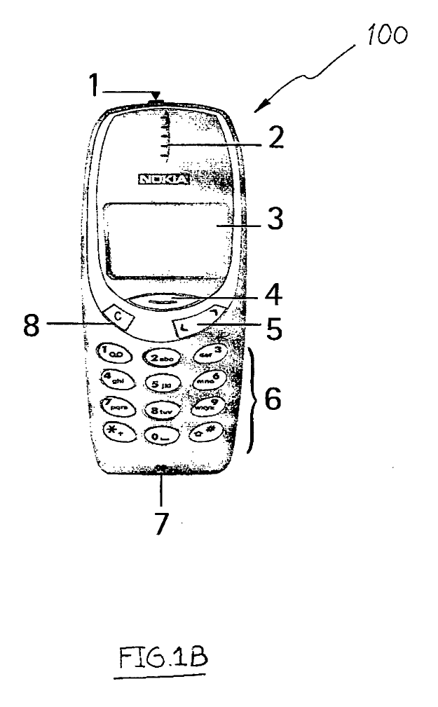

A user may enter the text message using the alphanumeric keypad 6 of the mobile phone. As each key is pressed a corresponding letter is displayed on the display 3. In this example, each key on the keypad 6 may also be associated with a particular frequency, or note on a musical scale. As can be seen in FIG. 2, in one embodiment, the composer function may have seven notes 210A-210G where each note is associated with a corresponding key 220A-220G from the keypad 6. Because there are only seven notes, keys one through seven from the keypad 6 are used to represent the notes 210A-210G. For example, the number one key 220A represents the “C” note 210A, the number two key 220B represents the “D” note 210B and so on. The keys corresponding to the numerals eight and nine on the keypad 6 may be used to respectively decrease or increase the duration of the notes while the clear key 8 may be used to erase unwanted notes. In alternate embodiments, any desired frequency can be assigned to a key or a character assigned to a key. For example, a key may be assigned to more than one character.

Referring to FIG. 1B, the key or button “2” is also assigned to the characters “a”, “b” and “c”. In one embodiment, a different frequency can be assigned to each of the characters assigned to a particular key or button. When a character is selected and inputted, the corresponding frequency will be recognized by the composer editor 180.

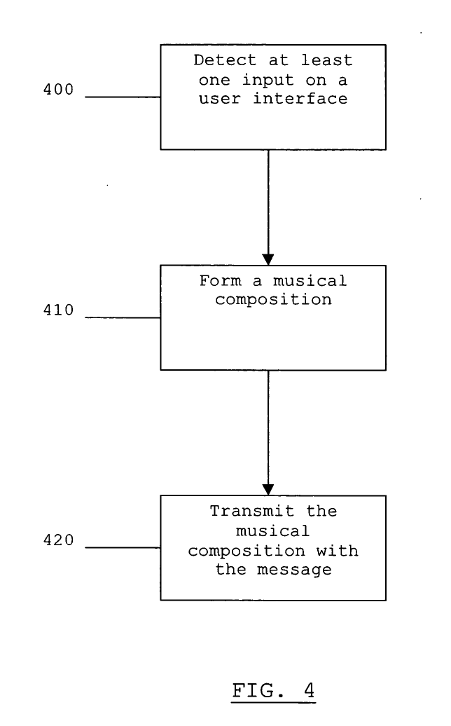

In operation, as the text message is entered, each of the key strokes input by the user are recorded in the memory 10 (FIG. 4, Block 400). For example, the memory may store any suitable information such as which key was pressed, how long the key was held down and/or the speed at which the text message was input (i.e. the time duration between pressing keys). When the text message is completed, the composer function may use the stored information as well as the above exemplary relationship between each key pressed and the note it represents to compose a musical composition corresponding to the text message (FIG. 4, Block 410). In alternate embodiments, the composer function may transpose the text into music as the text is being input.

In one embodiment, the speed with which the user enters or presses the keys can be used to create the tempo for the sound or melody that will result from the text message created. For example, if the user enters the characters for the text message very rapidly, the composition produced by the composer editor 180 can be similarly rapid. If the characters are entered into the message editor slowly, the resulting sounds produced by the composer editor 180 can have a similarly slow tempo. In alternate embodiments, any suitable correlation can be established.

For exemplary purposes, FIG. 3 shows a visual representation of a series of key strokes input by a user in accordance with this example. Each grouping 340 may represent the characteristics of one note. The first character 310 may represent the duration or tempo of the note (e.g. a whole note, half note, quarter note, etc.). The second character 320 represents the note itself. The third character 330 represents the octave of the note. The duration of the note may be determined in any suitable manner such as for example, from the length of time the user held down the key corresponding to a given note or from the speed or rhythm at which the user entered the text message (i.e. length of time between each key press), both of which may have been stored in the memory 10 as the text was being input. In alternate embodiments, the duration of each note may be altered each time a letter corresponding to the eight or nine keys is pressed or the duration may be user defined through a settings menu corresponding to the composer or text messaging functions. The octave for each note may also be set in any suitable manner such as for example, it may be user defined or it may be selected by pressing, for example the “star” key prior to inputting text. If the transposition of the musical composition is displayed on display 3 for the user to see, as shown in FIG. 3, a user may change the duration and octave of the notes using for example the scroll keys 5 and selection key 4 or if the display is a touch enabled display the user may change the duration and octave using a suitable pointing device.

Once each letter in the string of text is converted into the musical composition, the composition may be attached to the text message and sent to the receiving party (FIG. 4, Block 420).

In another exemplary embodiment, an incoming or received text message (without a musical composition attached to it) may be converted into a musical composition by the receiving phone. For example, the text messaging settings of the mobile phone 100 may have an option, that may be selected by a user, for converting incoming text messages to a musical composition. If this setting is switched on, the message editor 160 of the communication device 100 of FIG. 1A may recognize each letter in the string of text from the received message and store the information in memory 150 for use by the composer editor 180. The composer editor 180 can use the relationship between each letter (i.e. the key the letter corresponds to) and the corresponding notes to transpose the received text into music. The duration of each of the notes in this example may be altered in any suitable manner for example, the duration may be altered each time a letter corresponding to eight or nine key is recognized or the phone may randomly change the duration of each of the notes. The user may also define the duration of each of the notes in a settings menu of the device 100. The octave of each of the notes may also be user defined or randomly altered by the device 100.

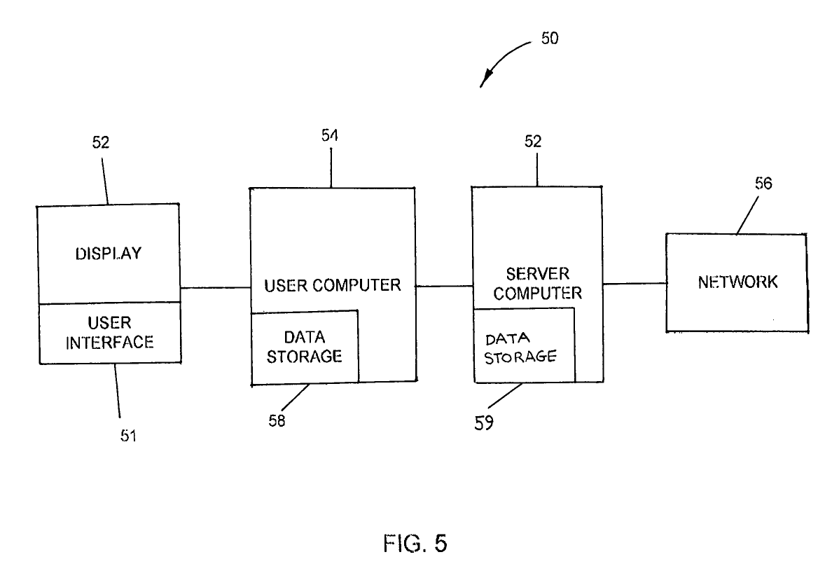

The disclosed embodiments may also include software and computer programs incorporating the process steps and instructions described above that are executed in different computers. FIG. 5 is a block diagram of one embodiment of a typical apparatus that may be used to practice the features of the disclosed embodiments. As shown, a computer system 50 may include a computer system 52 linked to another computer system 54, such that the computers 52 and 54 are capable of sending information to each other and receiving information from each other. In one embodiment, computer system 52 could include a server computer adapted to communicate with a network 56, such as for example, a telecommunications network. Computer systems 52 and 54 can be linked together in any conventional manner including a modem, hard wire connection, or fiber optic link. Generally, information can be made available to both computer systems 52 and 54 using a communication protocol typically sent over a communication channel or through a dial-up connection on ISDN line. Computers 52 and 54 are generally adapted to utilize program storage devices embodying machine readable program source code which is adapted to cause the computers 52 and 54 to carry out and perform the method steps of the disclosed embodiments. The program storage devices may be devised, made and used as a component of a machine utilizing optics, magnetic properties and/or electronics to perform the procedures and methods of the disclosed embodiments. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 52 and 54 may also include a microprocessor for executing stored programs. Computers 52 and 54 may include a data storage device 58, 59 on their program storage device for the storage of information and data. The computer program or software incorporating the processes and method steps incorporating features of the disclosed embodiments may be stored in one or more computers 52 and 54 on an otherwise conventional program storage device. In one embodiment, computer 54, which can comprise the device 100 of FIG. 1, may include a user interface 51, and a display interface 52 from which features of the invention can be accessed. The user interface 51 and the display interface 52 can be adapted to allow the input of queries and commands to the computer 54, as well as present the results of the commands and queries.

It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. An apparatus comprising:
a processor connected to a user interface; and
a character conversion device connected to the processor, the character conversion device being configured to convert character input through the user interface into a musical composition.

2. The apparatus of claim 1, further comprising:
a character recognition device connected to the processor, the character recognition device being configured to recognize at least one character of a received message;
wherein the character conversion device is further configured to convert the at least one recognized character of the received message into a musical composition.

3. The apparatus of claim 1, wherein the apparatus is a mobile telephone.

4. A method comprising:
detecting at least one key input to a user interface of a device, the at least one key input being used to form a message to be sent to a receiving device;
forming a musical composition from the at least one key input; and
transmitting the musical composition from the device to the receiving device when the message is sent to the receiving device.

5. The method of claim 4, further comprising:
receiving a message in the device from a sending device;
recognizing at least one character in the message; and
forming a musical composition from the at least one recognized character.

6. The method of claim 4, wherein the device is a mobile telephone.

7. The method of claim 4, wherein the at least one key input is stored in a memory of the device.

8. The method of claim 4, wherein a duration of the at least one key input is stored in a memory of the device.

9. The method of claim 4, wherein an input speed of the at least one key input is stored in a memory of the device.

10. The method of claim 9, wherein a tempo of the musical composition corresponds to the input speed of the at least one key input.

11. The method of claim 4, wherein forming a musical composition from the at least one key input occurs simultaneously with detecting the at least one key input.

12. The method of claim 4, wherein forming a musical composition from the at least one key input occurs after the message is formed.

13. A computer program product comprising:
a computer useable medium having computer readable code means embodied therein for causing a computer to form a musical composition, the computer readable code means in the computer program product comprising:
computer readable code means for causing a computer to detect at least one key input to a user interface of a device, the at least one key input being used to form a message to be sent to a receiving device;
computer readable code means for causing a computer to form a musical composition from the at least one key input; and
computer readable code means for causing a computer to transmit the musical composition from the device to the receiving device when the message is sent to the receiving device.

14. The computer program product of claim 13, further comprising:
computer readable code means for causing a computer to receive a message in the device from a sending device;
computer readable code means for causing a computer to recognize at least one character in the message; and
computer readable code means for causing a computer to form a musical composition from the at least one recognized character.

15. The computer program product of claim 13, further comprising computer readable code means for causing a computer to store an input speed of the at least one key input in a memory of the device, wherein a tempo of the musical composition corresponds to the input speed of the at least one key input.
